(19) United States
(12) Patent Application Publication
(10) Pub. No.: US 2021/0069702 A1
(43) Pub. Date: Mar. 11, 2021

(54) MICROFLUIDIC SENSING DEVICE AND CARTRIDGE, AND CORRESPONDING METHODS

(71) Applicant: CSEM Centre Suisse d'Electronique et de Microtechnique SA - Recherche et Développement, Neuchâtel (CH)

(72) Inventors: Noa SCHMID, Kriens (CH); Siegfried GRAF, Kriens (CH); Gilles WEDER, Cortaillod (CH); Silvia GENERELLI, Chur (CH); Nicolas GLASER, Basel (CH)

(21) Appl. No.: 17/017,359

(22) Filed: Sep. 10, 2020

(30) Foreign Application Priority Data
Sep. 11, 2019 (EP) 19196599.5

(51) Int. Cl. B01L 3/00

(52) U.S. Cl. CPC B01L 3/50273; B01L 3/502746; B01L 2300/0663; B01L 2300/0636; B01L 2300/0645; B01L 3/502738

(57) ABSTRACT

A microfluidic sensing device, for conducting measures on liquid samples, is disclosed, which includes a housing having: a first opening defining an inlet and/or an outlet for a liquid sample; a detection chamber including a sensor; a first microfluidic path connecting the first opening to the detection chamber, such that the detection chamber can be filled in with the liquid sample; a second opening designed so as to allow the application of a negative and/or positive pressure within the housing; a second microfluidic path connecting the second opening to the detection chamber; a third opening designed so as to allow the application of a negative and/or positive pressure within the housing; a third microfluidic path connecting the third opening to the first microfluidic path; and a waste chamber arranged in the second microfluidic path.

### TECHNICAL FIELD

The invention concerns a microfluidic sensing device, for conducting measures on liquid samples, comprising a housing having:
a first opening defining an inlet and/or an outlet for a liquid sample,
a detection chamber provided with at least one sensor, preferably an electrochemical sensor,
a first microfluidic path connecting the first opening to the detection chamber, such that the detection chamber can be filled in with a predefined volume of the liquid sample so as to conduct at least one measure,
a second opening designed so as to allow the application of a negative and/or positive pressure within the housing,
a second microfluidic path connecting the second opening to the detection chamber.

More precisely, the present invention relates to the field of molecular detection in liquid solutions, in particular by means of electrochemical sensors, i.e. sensors which provide an electric signal (voltage, current, impedance or power), which is a function of the concentration of certain molecules in the measured liquid sample. More particularly, the present invention concerns a microfluidic sensing device enabling this type of measurement by application on small (micro-liters) sample volumes, and which can be rinsed and reused several times with minimum waste as far as the liquid samples are concerned, and with no cross-contamination between successive measurements.

The invention further concerns a microfluidic sensing cartridge including at least two microfluidic sensing devices as mentioned above, as well as a method for manufacturing such a cartridge and a measurement method implementing such a sensing device or cartridge.

In particular, a low-cost disposable microfluidic sensing cartridge is disclosed, which can be used to analyze in parallel with minimum operation steps the concentration of specific biomolecules of cell-culture solutions distributed in standard multi-well plates.

### BACKGROUND

There are many types of methods that can be used for determining the concentration of molecules in a liquid sample. Methods based in e.g. optical readout (fluorescence, luminescence, or colorimetry) typically require relatively large amounts of sample. Others, based in molecular recognition and marking/or separation e.g. using magnetic beads, are not adequate for quantitative concentration measurements and are typically implemented for single-use positive/negative detection of target molecules.

Electrochemical sensors are on the other hand particularly well suited for measuring the concentration of molecules in an accurate, quantitative way, from a small sample volume and can be re-used several times if the sample is efficiently evacuated and renewed without cross-contamination between successive measurements.

Electrochemical sensors have been used for years now in particular for the measurement of glucose. When dealing with small sample volumes, the detector is typically provided in a microfluidic package which will transport a sample from the measured liquid to the detector by means of capillary forces. This mechanism is used in e.g. US2004/0256228 A1 to implement disposable electrochemical sensor strips, or in US2007/0131549 A1 to implement a disposable glucometer.

Passive liquid transport by capillary forces is in general an irreversible process and is therefore not adequate for a re-usable sensor.

Apart from this, active pneumatic actuation has been also implemented in microfluidic sensors. For example, US2009/0042280 A1 discloses a fluidic cartridge featuring multiple electrochemical sensors in a single detection chamber. Applying negative and positive pressure with a pneumatic actuator allows the entry and exit of a small volume liquid sample through a unique opening. The multi-analyte sensor is meant to be re-used in connection with multiple successive samples.

However, relying exclusively on pneumatic actuation for the regeneration of the sample volume as taught by this invention, may lead to cross-contamination due to residues of the samples left when applying positive pressure to evacuate the detection chamber. Indeed, as soon as the unique opening of the cartridge is partially open to let the air flow out, the positive pressure becomes ineffective to force the liquid film that is wetting the detection chamber out of it.

Thus, the need still exists for a low-cost disposable microfluidic sensing device which can be used to measure different successive liquid samples without any risk of cross-contamination.

### SUMMARY

An aim of the invention is to propose a microfluidic sensing device which overcomes the above-mentioned disadvantages of the prior art, which is disposable but can nevertheless be used to measure different successive liquid samples without any risk of cross-contamination.

More specifically, the invention relates to a microfluidic sensing device as stated above, and further comprising
a third opening designed so as to allow the application of a negative and/or positive pressure within the housing,
a third microfluidic path connecting the third opening to the first microfluidic path,
a waste chamber arranged in the second microfluidic path, and
a first restriction organ, for restricting the circulation of fluids, arranged in the second microfluidic path, between the second opening and the waste chamber, the first restriction organ having a predefined fluidic resistance so as to restrict the circulation of fluids in the second microfluidic path.

Thanks to these features, both capillary and pneumatic forces might be combined to handle a small predefined volume of a liquid sample into a detection chamber and, later, into a waste chamber which is directly part of the microfluidic sensing device. Furthermore, a major part of the liquid sample that is transported into the first microfluidic path but without reaching the detection chamber can be rejected back in the initial sample container without any risk of cross-contamination, by application of a positive pressure within the third microfluidic path.

Furthermore, the device might comprise a second restriction organ, for restricting the circulation of fluids, arranged in the third microfluidic path, the second restriction organ having a predefined fluidic resistance so as to restrict the circulation of fluids in the third microfluidic path.

In that case, it might be preferable to provide that the second restriction organ has a fluidic resistance which is at least 2 times lower, more preferably at least 5 times lower, than the fluidic resistance of the first restriction organ.

Advantageously, in this case, at least one of the first and second restriction organs may include a meander shaped channel having a reduced cross-section with respect to a mean cross-section of the corresponding microfluidic path.

Generally, it might be advantageous that a wicking pad is provided in the waste chamber.

Generally, it is possible to further provide that the device comprises
a main plate having a first side and a second side at least one of which is provided with at least one recess defining one or several items from the group comprising: the first microfluidic path, the second microfluidic path, the third microfluidic path, the detection chamber and the waste chamber, and
at least one sealing plate for sealing the at least one recess and/or at least one of the first and second sides.

According to a preferred embodiment, the first side of the main plate may comprise a recess defining the detection chamber, the first side then being sealed by a sealing plate bearing at least one electrically conducting track.

The invention also relates to a microfluidic sensing cartridge, for conducting at least two substantially simultaneous measures on at least two liquid samples, comprising a general housing having
at least two microfluidic sensing devices according to the above-mentioned features, as well as
a first distribution channel arranged in communication with the second opening of each of the at least two microfluidic sensing devices and having a first general opening designed so as to allow the application of a negative and/or positive pressure within the first distribution channel, and
a second distribution channel arranged in communication with the third opening of each of the at least two microfluidic sensing devices and having a second general opening designed so as to allow the application of a negative and/or positive pressure within the second distribution channel.

Thanks to these additional features, two or more microfluidic sensing devices can be actuated easily and simultaneously to measure as many liquid samples as there are sensing devices.

According to a preferred embodiment, eight microfluidic sensing devices may be arranged with respect to each other in a such a way that all of the eight corresponding first openings are substantially aligned.

Thanks to these features, this cartridge is adapted to fit into a standard 96-well cell culture plate. Indeed, these standard cell culture plates typically comprise 96 wells arranged in a 8×12 rectangular configuration. Thus, a same cartridge comprising eight parallel units can be used twelve successive times to conduct each time eight simultaneous measures on each of the twelve rows. Alternatively, it is possible to carry out the 96 measures simultaneously in one time by using twelve such cartridges comprising each eight measuring units.

The main plates of the different sensing devices might advantageously be made as one piece in this case defining a first general side and a second general side.

The invention also relates to a method for manufacturing such a microfluidic sensing cartridge comprising the steps consisting in:
providing a general main plate having at least two sets of recesses for defining the first microfluidic path, the second microfluidic path, the third microfluidic path, the detection chamber and the waste chamber for each of the at least two microfluidic sensing devices, one of the recesses being provided in the first general side for defining the detection chamber for each of the at least two microfluidic sensing devices,
providing a general sealing plate bearing an electrochemical sensor as well as at least one electrically conducting track for each of the at least two microfluidic sensing devices,
sealing the first general side with the general sealing plate, so as to arrange the electrochemical sensors substantially in alignment with the corresponding detection chambers,
providing a general cover plate for the second general side, and
sealing the second general side with the general cover plate.

The present invention further relates to a measurement method applied on at least one liquid sample by implementation of a microfluidic sensing device according to the above-mentioned features, comprising the steps consisting in:
immersing the first opening in a liquid sample,
applying a negative pressure in the housing at least through the third opening until the detection chamber is filled in with a predefined volume of the liquid sample,
applying a positive pressure in the housing through the third opening until any excessive part of the liquid sample is removed at least from a portion of the first microfluidic path located between the first opening and the third microfluidic path,
conducting at least one measure by means of the at least one electrochemical sensor, and
extracting the first opening out of the liquid sample before or after conducting the measure, but before applying a negative pressure in the housing through the second opening to transfer the predefined volume of the liquid sample from the detection chamber into the waste chamber.

Alternately, when a microfluidic sensing cartridge as mentioned above is used, a similar method might be implemented, the measurement being applied on N liquid samples, N being equal to or being a multiple of the number of microfluidic sensing devices in the microfluidic sensing cartridge, the method comprising the steps consisting in:
immersing the first opening of each of the at least two microfluidic sensing devices in a corresponding of the N liquid samples, in a substantially simultaneous manner,
applying a negative pressure in the general housing at least through the second general opening until the detection chamber of each of the at least two microfluidic sensing devices is filled in with a predefined volume of the corresponding liquid sample,
applying a positive pressure in the general housing through the second general opening until any excessive part of the liquid samples is removed at least from a portion of each of the first microfluidic paths located between the corresponding first opening and third microfluidic path,
conducting at least one measure on each of the at least two liquid samples by means of the corresponding at least one electrochemical sensor, in a substantially simultaneous manner, and
extracting the first openings out of the corresponding liquid samples before or after conducting the measures, but before applying a negative pressure in the general housing through the first general opening to transfer the predefined volume of the liquid samples from each of the detection chambers into the corresponding waste chambers.

As previously mentioned, the implementation of the measuring methods according to the present invention, in connection with a microfluidic sensing device or cartridge as stated above, allows successive measures of different liquid samples to be carried out with a same disposable microfluidic sensing device or cartridge without any risk of cross-contamination.

According to a preferred embodiment, the methods may further comprise a calibration step for calibrating the electrochemical sensor(s).

According to another preferred embodiment, the methods may further comprise a rinsing step of at least the first microfluidic path, respectively each of the at least two first microfluidic paths, before immersing the first opening in a liquid sample, respectively before immersing the first opening of each of the at least two microfluidic sensing devices in a corresponding of the at least N liquid samples, preferably by circulation of a buffer solution.

On a general basis, application of the negative and positive pressures through the second and third openings, respectively first and second general openings, may be implemented by means of a single pneumatic mechanism, in association with a valve.

Typically, the measuring method according to the preceding features might preferably be applied to predefined molecules within a cell culture media, more preferably to glucose or lactose.

### BRIEF DESCRIPTION OF THE DRAWINGS

Further details of the invention will appear more clearly upon reading the description below, in connection with the following figures which illustrate:

FIG. 1: schematic illustration of an exemplary embodiment of a microfluidic sensing device according to a preferred embodiment of the present invention;

FIG. 2: schematic illustration of an exemplary embodiment of a microfluidic sensing cartridge comprising a plurality of microfluidic sensing devices according to FIG. 1;

FIGS. 3a-3g: schematic views illustrating successive steps of a measuring method implementing the microfluidic sensing device of FIG. 1, according to a preferred embodiment of the present invention;

FIGS. 4a and 4b: simplified perspective views, from two opposite sides, of an exemplary actual implementation of a microfluidic sensing cartridge according to the present invention.

### DETAILED DESCRIPTION

The present invention relates to a disposable microfluidic sensing device for conducting successive analysis on liquid samples without any risk of cross-contamination. This device can take the form of a single unit or device, adapted to conduct measures on one liquid sample at a time, or it can take the form of a cartridge comprising two or more single units, preferably eight, adapted to conduct simultaneous measures at a time in connection with as many liquid samples as there are single units.

Same numerical references might be used for designating same components in different drawings in order to simplify the present disclosure of the invention and ease its understanding.

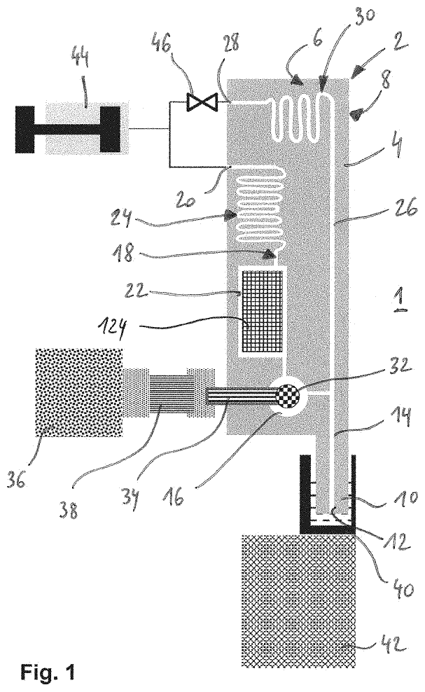

The general principle of the invention will now be explained in connection with a simple exemplary unit or device, as schematically illustrated on FIG. 1.

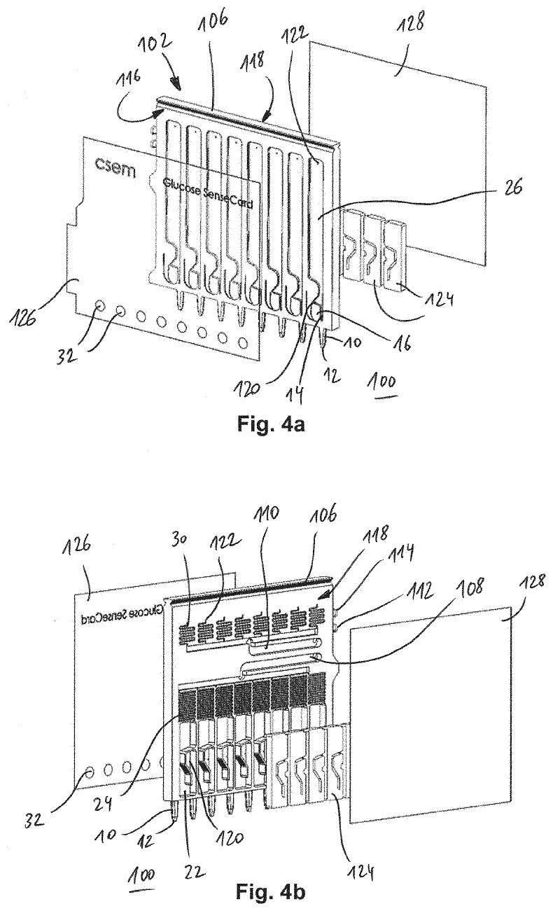

The microfluidic sensing device 1 according to a preferred exemplary embodiment of the present invention comprises a housing 2 including a main plate 4 having first and second sides 6 and 8, preferably sealed by sealing plates (visible in FIGS. 4a and 4b).

The main plate 4 has here a general parallelepiped shape with a tip 10 extending from a border, and is provided with a plurality of recesses defining different components of the microfluidic sensing device 1.

More particularly, a first opening 12 is arranged at the end of the tip 10 to define an inlet and/or an outlet for a liquid sample, a first microfluidic path 14 connecting the first opening 12 to an additional recess defining a detection chamber 16.

A second microfluidic path 18 is provided to connect the detection chamber 16 to a second opening 20 of the housing 2, this second opening 20 being designed to allow the application of a negative and/or a positive pressure in the housing 2 through the second microfluidic path 18, as will be described further in more detail.

In the direction from the detection chamber 16 to the second opening 20, the second microfluidic path 18 is further provided with a first additional recess defining a waste chamber 22 and with a first restriction organ 24 for restricting the circulation of fluids through the second microfluidic path 18.

A third microfluidic path 26 is provided to connect a third opening 28 to the first microfluidic path 14 through a second restriction organ 30, for restricting the circulation of fluids through the third microfluidic path 26.

The third opening 28 is also designed to allow the application of a negative and/or a positive pressure in the housing 2 through the third microfluidic path 26, as will be described further in more detail.

An electrochemical sensor 32 is advantageously provided in the detection chamber 16, in order to conduct measures on liquid samples, as well as at least one electrically conducting track 34 intended to be connected to a measuring apparatus 36 through an adapted physical interface 38, so that the electrical signals generated by the electromechanical sensor 32 can be computed into measuring values, in a well-known manner.

A well 40 is further illustrated in FIG. 1, which contains a liquid sample to be measured by the microfluidic sensing device 1, the tip 10 being immersed in the liquid sample so as to transfer a part of it to the detection chamber 16. The well 40 might advantageously be supported by a mobile support 42 which might be elevated or lowered so as to immerse the tip 10 in the liquid sample or get the tip 10 out of the liquid sample without any need to move the microfluidic sensing device 1.

A pneumatic mechanism 44 is also schematically illustrated, here connected to both second and third openings 20 and 28, in order to apply negative and/or positive pressure in the housing 2 when required. A valve 46 might be advantageously provided between the pneumatic mechanism 44 and the third opening 28 so that a pressure can be applied within the housing 2 through the second opening 20 exclusively, as will be explained further. Alternatively, two distinct and independent pneumatic mechanisms might be connected to the second and third openings 20 and 28 without going beyond the scope of the present invention.

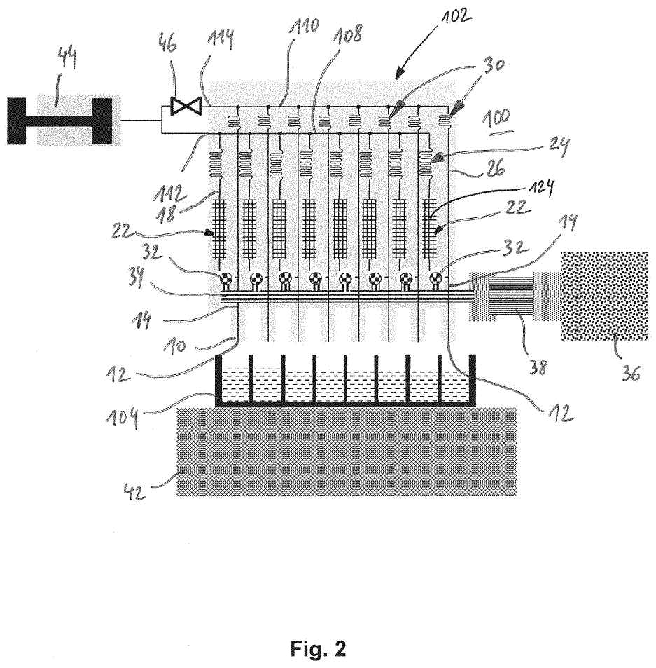

FIG. 2 schematically illustrates a microfluidic sensing cartridge 100 according to an exemplary preferred embodiment of the present invention.

Advantageously, this cartridge 100 includes at least two, here eight, microfluidic sensing devices 1 as described above gathered within a same general housing 102.

All the sensing devices 1 are preferably arranged substantially parallel to each other such that their tips 10 are aligned and can be immersed simultaneously in eight corresponding wells of a standard 96-well cell culture plate 104.

If it is obviously advantageous to manufacture all the main plates 4 of all the devices 1 so that they are gathered altogether in a single general main plate 106, but the one skilled in the art may implement any other arrangement without going beyond the scope of the present invention.

Further, it is also preferable to provide a first distribution channel 108 arranged simultaneously in communication with all the second openings 20 of all the devices 1, as well as a second distribution channel 110 arranged simultaneously in communication with all the third openings 28 of all the devices 1. Thanks to these two distribution channels, one pneumatic mechanism 44 can be used only, as is the case with a single microfluidic sensing device 1, and be connected to both a first general opening 112 of the first distribution channel 108 and a second general opening 114 of the second distribution channel 110. It is preferable to provide a valve 46 in the case of a single pneumatic mechanism 44, as explained above.

Electrically conducting tracks 34 are preferably arranged to connect all of the electrochemical sensors 32 to a single measuring apparatus 36 through a single physical interface 38, so that the electrical signals generated by all the electromechanical sensors 32 can be computed into measuring values, in a well-known manner.

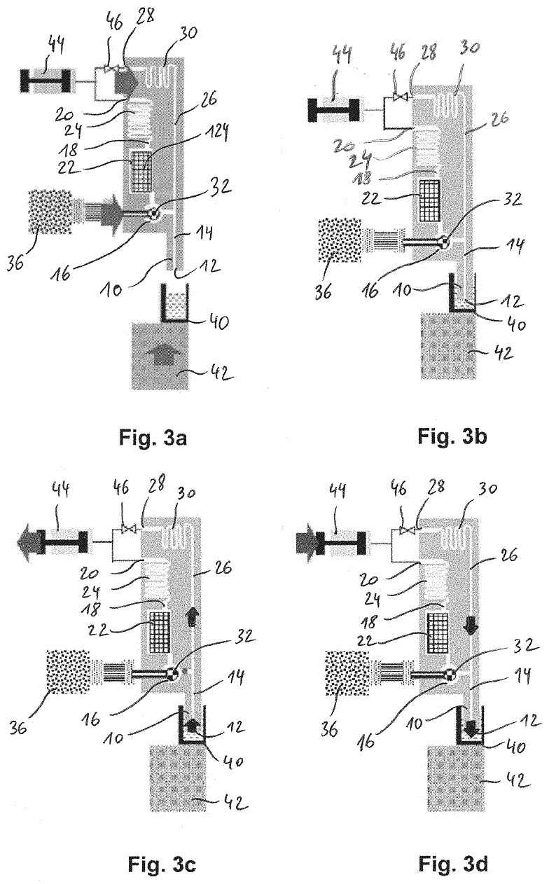

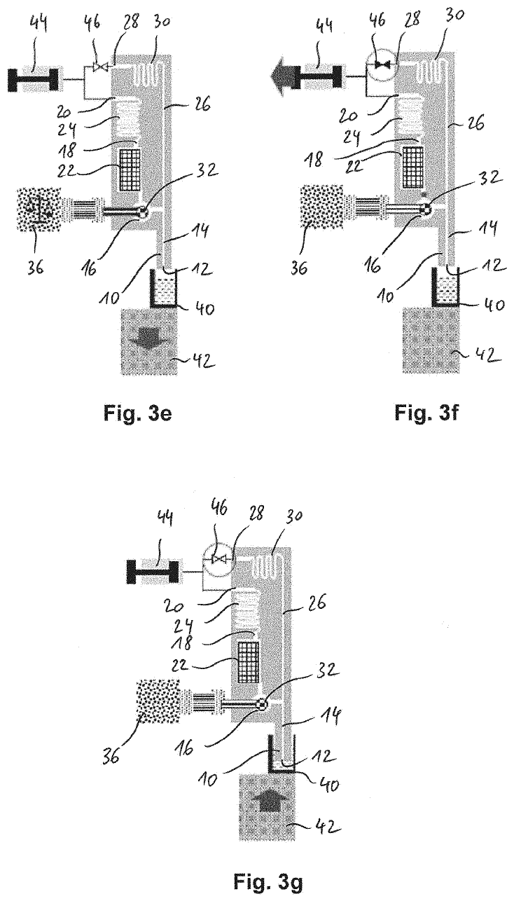

Next, a preferred embodiment of a measurement method based on the implementation of a microfluidic sensing device 1 will be described thanks to the illustrations of FIGS. 3a to 3g, schematically showing chronological steps of the method.

First, as illustrated in FIG. 3a, the pneumatic mechanism 44 is connected to the second and third openings 20 and 28 so as to be able to apply negative and/or pressure in the housing 2.

The measuring apparatus 36 is also connected to the electrochemical sensor 32, through the interface 38, so that the results of the measures can be analysed.

If necessary, the measurement method can start with a preliminary calibration step and/or a rinsing step for preparing the device 1 for the measures.

Then, the tip 10 of the device 1 can be immersed in the liquid sample stored in the well 40, either by lowering the device 1 or, preferably, by elevation of the mobile support 42 until the first opening 12 arranged in the tip 10 is immersed in the liquid sample, as illustrated in FIG. 3b.

The pneumatic mechanism 44 is actuated next, to apply a negative pressure in the housing 2, as schematically illustrated by means of arrows.

Different alternate embodiments can be implement here without going beyond the scope of the invention. According to a preferred embodiment, a same pneumatic mechanism 44 is connected to both openings 20 and 28, but the corresponding restriction organs 24 and 30 have different fluidic resistance values, such that the fluidic resistance of the second microfluidic path 18 is higher than that of the third microfluidic path 26. For instance, the second restriction organ 30 may have a fluidic resistance which is at least 2 times lower, more preferably at least 5 times lower, than the fluidic resistance of the first restriction organ 24. Alternately, as previously mentioned, it is also possible to provide two distinct and independent pneumatic mechanisms so that different pressures can be applied respectively in the second microfluidic path 18 and in the third microfluidic path 26.

Coming back to FIG. 3c, the applied negative pressure implies a transfer of the liquid sample essentially along a first portion of the first microfluidic path 14 and then along the third microfluidic path 26.

However, a part of the liquid sample reaching the junction area of the third microfluidic path 26 with the first microfluidic path 14 is transferred further along the first path 14, in the direction to the detection chamber 16, as the result of the application of capillary forces, and the negative pressure applied by the pneumatic mechanism 44 in the housing 2, in combination with these capillary forces.

The negative pressure is applied until the detection chamber 16 is filled in with a predefined volume of the liquid sample.

Once the required predefined volume of the liquid sample is in the detection chamber 16, a positive pressure is applied in the housing 2 by appropriate actuation of the pneumatic mechanism 44, as illustrated by means of arrows in FIG. 3d.

Here again, most of the applied pressure is transferred to the liquid sample which is present within the housing 2 of the device 1 through the third microfluidic path 26 as far as its fluidic resistance is lower than that of the second microfluidic path 18. In the case of two independent pneumatic mechanisms, only the one which is connected to the third opening 28 might be actuated to apply a positive pressure in the third microfluidic path 26.

The applied pressure results in pushing the volume of the liquid sample in excess back to the well 40. More precisely, all of the liquid sample that was in the third microfluidic path 26 and in the portion of the first microfluidic path 14 located between the first opening 12 and the junction with the third microfluidic path 26 is removed by being pushed back into the well 40.

Only a minor part of the liquid sample located in the first microfluidic path 14, between the junction with the third microfluidic path 26 and the detection chamber 16, may possibly stay in the housing 2 without being sensed by the electrochemical sensor 32.

The difference between the respective fluidic resistances of the second microfluidic path 18 and of the third microfluidic path 26 is such that the volume of the liquid sample in the detection chamber 16 remains virtually unchanged during application of the positive pressure.

After the excess volume of the liquid sample is removed from the housing 2, the tip 10 can be extracted out of the well 40, advantageously by lowering the mobile support 42, and the measure(s) by the electrochemical sensor 32 can take place, as illustrated in FIG. 3e.

Once the measure(s) is/are completed, the predefined volume of the liquid sample can be pulled out of the detection chamber 16 to be transferred into the waste chamber 22, by application of a negative pressure within the second microfluidic path 18, as schematically illustrated in FIG. 3f. To ensure that this negative pressure applies to the content of the second microfluidic path 18, the valve 46 is closed, so that no negative pressure is applied in the third microfluidic path 26. In the case of two independent pneumatic mechanisms, only the one connected to the second opening 20 would be actuated to apply a negative pressure in the second microfluidic path 18.

Once the detection chamber 16 is empty again, a new cycle can start as illustrated in FIG. 3g and the valve 46 can be re-opened.

If necessary, a calibration step and/or a rinsing step for preparing the microfluidic sensing device 1 for the next measures can be carried out.

When the microfluidic sensing device 1 is ready for the next measuring operation, the tip 12 can be immersed in a new liquid sample to start a new cycle as described as from FIG. 3b.

As far as the microfluidic sensing cartridge 100 of FIG. 2 is concerned the same measuring method can be implemented and it will thus not be described here in detail.

As visible in FIG. 2, the pneumatic mechanism 44 and the valve 46 are connected to the first general opening 112 of the first distribution channel 108 and to the second general opening 114 of the second distribution channel 110. Consequently, when the above described measurement method is implemented in connection with a cartridge 100 instead of the microfluidic sensing device 1, the first general opening 112 plays the role of the second opening 20 and the second general opening 114 plays the role of the third opening 28.

Generally, the measurement method implemented in connection with a cartridge allows N simultaneous measures to take place, N being equal to the number of microfluidic sensing devices 1 included in the cartridge under consideration.

For instance, a cartridge 100 comprising eight devices 1 can be used to simultaneously conduct measures on eight different liquid samples. Thus, twelve successive measurement cycles would be necessary to analyse all 96 liquid samples of a standard 96-well cell culture plate 104.

It appears from what precedes that the present invention has several advantages with respect to prior microfluidic sensing devices.

In particular, there is no loss of liquid sample in a dead volume of the housing. Any liquid that is not used in the detection chamber 16 can be returned to the original sample without contamination. This concerns, in particular, the dead volume between the first opening 12 and the detection chamber 16. This possibility is enabled by the provision of the third microfluidic path 26 connecting the pneumatic mechanism 44 to the first opening 12. Through this connection, which bypasses the waste chamber 22 and the detection chamber 16, the dead volume which has not been in contact with the electrochemical sensor 32 can be transferred back into the original sample.

Further, the design of the device 1 facilitates the parallelization of multiple units avoiding partial filling or unnecessary waste. This is again provided by the third microfluidic path 26. If this third path 26 did not exist and the device had only single fluidic paths going from the first opening 12 to the detection chamber 16, and from the detection chamber 16 to the second opening 20 through the waste chamber 22, and this was implemented for several devices 1 distributed in parallel and being all connected to the same pneumatic mechanism 44, then small differences in the fluidic resistances of the different devices would translate into varying filling rates of the corresponding detection chambers 16. At some point the devices 1 with lower fluidic resistance would be already transferring liquid into the waste chamber 22 while the detection chambers 16 in the high-resistance devices 1 would be still partially filled. The result would be, again, a waste of sample. According to the design of the invention, the detection chamber 16 is filled from the liquid drawn into the last portion of the first microfluidic path 14 by capillary forces combined with some negative pressure applied through the second microfluidic path 18. In a parallel configuration, the third microfluidic paths 26, which have a reduced fluidic resistance compared to the second microfluidic paths 18 connected to the detection chambers 16 can get all filled in parallel by the negative pressure applied directly through the third opening 28 and through the second distribution channel 110. From there the liquid spreads into the detection chambers 16 at different rates, but without waste. Indeed, the negative pressure applied through the first distribution channel 108 and the second microfluidic paths 18 is not strong enough to draw the liquid from the detection chamber 16 into the waste chamber 22. For this, the restriction organs 24 behind the waste chambers 22 are made more constraining than the restriction organs 30 provided in the third microfluidic paths 26. The third microfluidic paths 26 of the different devices 1 will be more or less filled by the common negative pressure applied to the second distribution channel 110. The rates at which the detection chambers 16 get filled will vary from device to device, but at some point they will all be completely filled without having lost any volume into the waste chambers 22. The different dead volumes that were left in the third microfluidic paths 26 are restituted to the wells 40 and only the volume of the detection chamber 16 will have been extracted from each of the liquid samples, regardless of the differences in fluidic resistance of the different devices.

The sensing device 1 exhibits a limited risk of cross-contamination of liquid samples thanks to evacuation of the measured liquid into the waste chamber 22, which can advantageously feature a wicking pad which retains the liquid by capillary forces. The risk of cross-contamination is further lowered thanks to the fact that the liquid paths into and out of the detection chamber 16 are distinct (no reversing of liquid flow).

Moreover, the operation of the device 1 is simplified with respect to that of prior art devices as far as it is not necessary to move the device 1 to an external waste flask after each measurement as must be done with a device having a single opening as sample inlet-outlet paths.

FIGS. 4a and 4b illustrate an actual exemplary preferred embodiment of a microfluidic sensing cartridge 100 comprising eight microfluidic sensing devices 1, as previously described.

The cartridge 100 comprises a general main plate 106 having eight sets of identical recesses, some of which are arranged on a first side 116 of the plate 106, the others being arranged on the second side 118 of the plate 106.

More precisely, in each unit, a first microfluidic path 14 emerges from the end of a tip 10 in the first side 116, next to a detection chamber 16. A third microfluidic path 26 is also arranged on the first side 116 and communicates with the first microfluidic path 14.

A first through hole 120 links the detection chamber 16 to a waste chamber 22 arranged on the second side 118 of the general main plate 106. A second microfluidic path 18 extends then from each waste chamber 22 to a first distribution channel 108, through a first restriction organ 24. The first distribution channel 108 then extends through the general main plate 106 to a first general opening 112 intended to be connected to a pneumatic mechanism.

A second through hole 122 links each portion of the third microfluidic path 26 arranged on the first side 116 of the general main plate 106 to another portion of the third microfluidic path 26 arranged on the second side 118 and comprising in particular a second restriction organ 30 before connecting to a second distribution channel 110 which extends through the general main plate 106 to a second general opening 114, also intended to be connected to a pneumatic mechanism.

According to this preferred exemplary embodiment, both first and second restriction organs 24 and 30 include a meander shaped channel having a reduced cross-section with respect to a mean cross-section of the corresponding microfluidic path.

As previously mentioned, a wicking pad 124 is preferably arranged in each waste chamber 22 in order to avoid any leakage of the waste liquids.

Finally, a sealing plate 126 is used to seal the first side 116 of the cartridge 100, this sealing plate preferably having at least one electrochemical sensor 32 printed for each unit 1 as well as a required number of electrically conducting tracks 34 (not visible in FIGS. 4a and 4b), the electrochemical sensors 32 being located so as to be aligned with the corresponding detection chambers 16 of the first side 116.

A simple cover plate 128 is used to seal the second side 118 of the cartridge 100.

Alternatively, the waste chambers 22 could be on the first side 116 of the general main plate 106, holding the wicking pads 124, such that the second side 118 could be realized without any tape or cover plate 128 to close off.

Furthermore, calibration, washing/rinsing and storage solutions could be stored directly in the cartridge in liquid reservoirs e.g. blisters, pouches, syringes or any other storage vessel (not illustrated) without going beyond the scope of the present invention.

The general main plate 106 can advantageously be made of bio compatible plastic and designed to be injected molded, hot embossed, manufactured by additive manufacturing, milled, cast or any other known manufacturing method. The main microfluidic paths may preferably have cross sections of 1 mm by 0.5 mm. The channels in the restriction organs 24, 30 however have cross sections of about 0.4 mm by 0.2 mm or smaller. The length of the first restriction organ 24 may be in the order of 140 mm while that of the second restriction organ may be in the order of 60 mm. The meander channel of the first restriction organ 24 may be by purpose about the double of the length of that of the second restriction organ 30 in order to increase the flow resistance in the second microfluidic path 18 if a same pneumatic mechanism 44 is connected to both second and third openings 20 and 28. If two individual pneumatic actuators would be used, the restrictions of the two flow paths could be similar. Instead of having long channels, the restriction organs could have shorter channels but narrower cross sections as e.g. a tiny capillary, a foam like structure or any other structure and/or material which results in a similar flow resistance.

With the above mentioned restriction organ design, aqueous media can be analyzed. For higher viscous media, the flow resistances of the flow restriction organs have to be increased proportionally.

The detector chamber 16 may have a width of about 4 mm and a depth of 0.23 mm to hold 5 ul sample. The tips 10 may generally have a length between 1 and 30 mm, preferably between 6 and 10 mm, but can be customized to any other length.

The waste chamber 22 to hold the analyzed media is designed to hold about 400 ul but can be customized to any other size. This 400 ul volume allows to perform more than 40 measurements before the waste chamber 22 is full.

The sealing plate 126 for the first side 116, or sensor foil, may advantageously be a heat-stabilized PET foil with printed sensing electrodes and electrical connections and/or tracks. The sensing electrodes can be made of a functional printing method such as screen printing, inkjet printing, aerosol jet printing, offset- or gravure printing.

The sensing electrodes must then be functionalized in several steps to later measure the appropriate molecule e.g. sense glucose. Electrochemical sensing is a versatile and efficient tool for multi-parametric analysis within different cell culture media.

All the sensors mentioned here can be prepared using a screen printing technology. Molecules that can be sensed using the electrochemical sensors include, but are not restricted to, glucose, lactate, uric acid, pH, K⁺, Na⁺ and other small ions.

Corresponding examples of functionalization protocols follow.

Amperometric EC sensors (e.g. glucose, lactate, uric acid):

These sensors are prepared with at least one layer, where the relevant enzyme is trapped. Additional layers for mediators, stabilization agents, covering layers etc. may be necessary for an optimal sensor response. The layer(s) are in general applied on the working electrode by drop casting.

Ion EC sensors:

For the fabrication of these sensors, a selective membrane specific for the ion of interest has to be immobilized on the working electrode surface of the screen printed electrode. This selective membrane is usually prepared as a mix of:
organic solvent
plasticizer(s)
Ionophore (the molecule that selectively bounds to the ion of interest)

The mixture solution (specific for the ion to be monitored) is then applied on the working electrode by drop casting.

As far as the cover plate 128 is concerned, it may be a foil with an adhesive layer on one side. It can be cut using water jet, laser, die cutting, scissors, scalpel or any other known method for structuring. The tape can be transparent but also colored to prevent the view on the internal structure.

The wicking pad material should absorb liquid and provide enough liquid retention to overcome the capillary forces by the second microfluidic path 18 and the detection chamber 16. The material may be a blotting paper (e.g. Thermofisher Scientific LC2008) with a volume of 400 ul. It can be cut using water jet, laser, die cutting, scissors, scalpel or any other known method for structuring.

As far as the overall assembly is concerned, the sealing plate 126 is preferably glued onto the general main plate 106, by means of applying a biocompatible glue (Loctite 3211) on one or both sides of the elements by means of printing or coating. The glue is UV-crosslinked from the back side of the sensor once the two elements are assembled. Alternate implementations are of course possible here, like for instance using a structured double adhesive tape instead of the glue, without going beyond the scope of the present invention.

Next, the wicking pads are inserted into the waste chambers 22 arranged in the second side 118 of the general main plate 106 which is then closed off with the cover tape 128.

Then the whole assembly may be vacuum packed and stored at 4° C.

Finally, the packed assembly is preferably gamma sterilized between 25 k and 30 kGy (Synergy Health Däniken AG).

Now, a detailed example will be disclosed in an illustrative and non-limiting manner. This detailed example relates to the manufacture of a microfluidic cartridge 100 corresponding to the previous description as well as to its use to conduct measures on liquid samples.

The general main plate 106 was 3D printed using the Miicraft 100X and the biocompatible resin MDP. After cleaning and UV curing the scaffold was removed and the sensing chambers hydrophilized using OptoDex (Trademark) technology (information can be found here: https://www.csem.ch/optodex).

The wicking pads 124 are laser cut from a larger sheet of blotting paper (Thermofisher Scientific LC2008). After the wicking pads 124 are put into the waste chambers 22 of the general main plate 106, the cover plate 128 (CSEM C150) is laminated onto it and cut.

The sealing plate 126 is a heat-stabilized PET foil with printed electrochemical sensors 32 including the above mentioned sensing electrodes and electrical connections or tracks 34. The sensing electrodes are made through a functional printing method such as screen printing, inkjet printing, aerosol jet printing, offset- or gravure printing. Each of the electrochemical sensors 32 comprises three functional electrodes of which one is a reference electrode made of Ag:AgCl, which may be coated with a electrolyte containing polymer or hydrogel, the second electrode being a counter electrode made of an electrically conductive material and the third electrode being a working electrode made of electrically conductive carbon gold, or platinum. Furthermore, an opaque and high viscous dielectric paste is printed around the sensing area in order to define the sensing electrodes and to shield the UV light for the subsequent glueing process. An insulation dielectric paste is printed on the remaining sensing foil to protect the electrical leads from the sensing liquid. The electrochemical sensors 32 are then functionalized in several steps to later measure the appropriate molecule e.g. sense glucose. Then the sealing plate 126, or sensor foil, is glued onto the general main plate 106, by means of applying a biocompatible glue (Loctite 3211) on one or both sides of the elements by means of printing or coating. The glue is UV-crosslinked from the back side of the sensor once the two elements are assembled. Then the whole assembly is vacuum packed and stored at 4° C.

Finally, the packed assembly is gamma sterilized between 25 k and 30 kGy (Synergy Health Däniken AG).

As far as the setup is concerned, a syringe (currently 20 ml) with two tubings (currently Semadeni 4349) and one pinch valve (currently Semadeni 616) is connected to the cartridge 100 at the first and second general openings 112, 114. Instead of a syringe actuator, any other kind of pneumatic actuator as e.g. a bi-directional pump arrangement could be used. Additionally, a flexible circuit board (FCB) connector (playing the role of the physical interface 38) is slid over the electrical connections of the sealing plate 126. The other end of the FCB connector is mounted on a multiplex reader (Palmsens MultiStat and MUX8) which is connected via USB to a computer having installed the appropriate software for the reader. The well plate 104 is positioned on a lift table 42 (for instance Lab jack SwissBoy 110). This way the penetration depth of the tips 10 can be well controlled and repeated e.g. using an alignment mark on the lift table's knob. Alternatively, the well plate 104 could be fixed and the cartridge 100 mounted on an YZ-stage.

As already explained, the cartridge 100 is designed to be able to pneumatically aspirate a liquid sample through all the tips 10 in parallel (i.e. simultaneously). Therefore, all tips 10 have to be in contact with the culture media of a standard reservoir as e.g. a 96 well plate 104 or any other format or arrangement.

The suction is performed with a syringe (currently 20 ml) or any other air pump which is connected to the fluidic connection ports (first and second general openings 112, 114). The second general opening 114 connects towards the second distribution channel 110, while the first general opening 112 connects towards the end of the detection chambers 16, via the first distribution channel 108. Additionally, a manual pinch valve 46 is placed onto the tubing connecting the second general opening 114. The aspirated liquid volume is about 10 ul (derived from the design file). While the liquid is aspirated, the detection chamber 16 (volume of 5 ul) fills via pneumatic and capillary forces using the hydrophilic property of the sensing cavity.

As soon as the detection chambers 16 are full, the aspiration can be stopped and the dispensing of the remaining liquid (about 5 ul derived from the design file) back into the well plate 104 can be initiated. Because this part of the liquid was never in contact with the sensors 32 (cavity) it will not alter the cell culture. Alternatively, this part of the liquid could also be kept in the cartridge 100 and finally be moved to the on-cartridge waste chambers 22 after the measurement.

The cartridge 100 is then removed from the multi well plate 104 (by lowering the lift table 42) to perform the measurement before a final aspiration is started to empty the detection chambers 16 into the on-cartridge waste chambers 22 by closing the pinch valve 46 and apply suction only to the detection chambers 16 to empty them. In the waste chambers 22 the wicking pads 124 are designed with a volume of 423 ul and can hold up to 400 ul of liquid (measured with a balance). To support the parallel actuation of all channels, air restriction organs 24 and 30 after the detection chambers 16 and the third microfluidic path 26 compensate from minor differences between the microfluidic paths. The differences might come from manufacturing, the assembly or the fluid (impurities which might partially obstruct the flow).

As far as the performance of a quantification of glucose in cell culture is concerned, the sensors 32 require a first 3-point-calibration and afterwards for each measurement a 1-point-calibration to compensate for signal losses due to altering. In between each measurement a wash solution is used to clean the paths/channels and detection chambers 16. These operations are standard and the one skilled in the art will encounter no difficulty to select appropriate solutions and implementation conditions as a function of his specific needs without going the scope of the invention. Our cell culture was performed in DMEM+10%FBS+1% PenStrp but could also be done in different media also containing no FBS or PenStrp.

For each calibration, wash or measurement step, the well plate 104 containing the liquid/cell culture is moved up by the lift table 42 towards the cartridge 100. As soon as the tips 10 are in contact with the liquid samples, the latter is aspirated until the detection chambers 16 are filled with the liquid. The excessive volumes of liquid samples can then be returned by dispensing. Before a first air bubble forms at the tips 10, the well plate 104 is lowered using the lift table 42. At this point the measurement can be initiated on the computer. Currently, the sensors 32 are subsequently readout each for 30 seconds. Alternately, the sensors 32 might be readout simultaneously. Then, the pinch valve 46 is closed and the liquid in the detection chambers 16 is aspirated into the waste chambers 22. Finally, the pinch valve 46 is opened again and the cartridge 100 is ready for another cycle.

The present invention provides a simple manufacturing method for obtaining a low cost and disposable microfluidic sensing device with a great designing freedom, allowing the manufacture of two or more parallel units, and at the same time allowing to carry out successive liquid sample analysis with no risk of cross-contamination.

Although the invention has been described in terms of particular embodiments, various modifications are possible without departing from the scope of the invention as defined in the appended claims.

What is claimed is:

1. A microfluidic sensing device, for conducting measures on liquid samples, comprising a housing having:
a first opening defining an inlet and/or an outlet for a liquid sample,
a detection chamber provided with at least one sensor,
a first microfluidic path connecting said first opening to said detection chamber, such that said detection chamber can be filled in with a predefined volume of the liquid sample so as to conduct at least one measure,
a second opening designed so as to allow the application of a negative and/or positive pressure within said housing,
a second microfluidic path connecting said second opening to said detection chamber,
said microfluidic sensing device further comprising:
a third opening designed so as to allow the application of a negative and/or positive pressure within said housing,
a third microfluidic path connecting said third opening to said first microfluidic path,
a waste chamber arranged in said second microfluidic path, between said detection chamber and said second opening, and
a first restriction organ, for restricting the circulation of fluids, arranged in said second microfluidic path, between said second opening and said waste chamber, said first restriction organ having a predefined fluidic resistance so as to restrict the circulation of fluids in said second microfluidic path.

2. The device of claim 1, further comprising a second restriction organ, for restricting the circulation of fluids, arranged in said third microfluidic path, said second restriction organ having a predefined fluidic resistance so as to restrict the circulation of fluids in said third microfluidic path.

3. The device of claim 2, wherein said second restriction organ has a predefined fluidic resistance which is at least 2 times lower, more preferably at least 5 times lower, than the predefined fluidic resistance of said first restriction organ.

4. The device of claim 1, wherein at least one of said first and second restriction organs includes a meander shaped channel having a reduced cross-section with respect to a mean cross-section of the corresponding microfluidic path.

5. The device of claim 1, wherein a wicking pad is provided in said waste chamber.

6. The device of claim 1, wherein it comprises:
a main plate having a first side and a second side at least one of which is provided with at least one recess defining one or several items from the group comprising: said first microfluidic path, said second microfluidic path, said third microfluidic path, said detection chamber and said waste chamber, and
at least one sealing plate for sealing said at least one recess and/or at least one of said first and second sides.

7. The device of claim 6, wherein said first side of said main plate comprises a recess defining said detection chamber, and wherein said first side is sealed by a sealing plate bearing at least one electrically conducting track.

8. The device of claim 1, wherein said sensor is an electrochemical sensor.

9. A microfluidic sensing cartridge, for conducting at least two substantially simultaneous measures on at least two liquid samples, comprising a general housing having at least two microfluidic sensing devices each of which includes:
a first opening defining an inlet and/or an outlet for a liquid sample,
a detection chamber provided with at least one sensor,
a first microfluidic path connecting said first opening to said detection chamber, such that said detection chamber can be filled in with a predefined volume of the liquid sample so as to conduct at least one measure,
a second opening designed so as to allow the application of a negative and/or positive pressure within said housing,
a second microfluidic path connecting said second opening to said detection chamber,
a third opening designed so as to allow the application of a negative and/or positive pressure within said housing,
a third microfluidic path connecting said third opening to said first microfluidic path,
a waste chamber arranged in said second microfluidic path, between said detection chamber and said second opening, and
a first restriction organ, for restricting the circulation of fluids, arranged in said second microfluidic path, between said second opening and said waste chamber, said first restriction organ having a predefined fluidic resistance so as to restrict the circulation of fluids in said second microfluidic path
said microfluidic sensing cartridge further comprising:
a first distribution channel arranged in communication with said second opening of each of said at least two microfluidic sensing devices and having a first general opening designed so as to allow the application of a negative and/or positive pressure within said first distribution channel, and
a second distribution channel arranged in communication with said third opening of each of said at least two microfluidic sensing devices and having a second general opening designed so as to allow the application of a negative and/or positive pressure within said second distribution channel.

10. The cartridge of claim 9, wherein each of said at least two microfluidic sensing devices further comprises a second restriction organ, for restricting the circulation of fluids, arranged in said third microfluidic path, said second restriction organ having a predefined fluidic resistance so as to restrict the circulation of fluids in said third microfluidic path.

11. The cartridge of claim 9, having eight microfluidic sensing devices arranged with respect to each other in such a way that all of said eight corresponding first openings are substantially aligned.

12. The cartridge of claim 9,
wherein each of said at least two microfluidic sensing devices comprises:
a main plate having a first side and a second side at least one of which is provided with at least one recess defining one or several items from the group comprising: said first microfluidic path, said second microfluidic path, said third microfluidic path, said detection chamber and said waste chamber, and
at least one sealing plate for sealing said at least one recess and/or at least one of said first and second sides, and
wherein all of said corresponding main plates are made as one piece defining a first general side and a second general side.

13. The cartridge of claim 9, wherein said sensor is an electrochemical sensor.

14. A method for manufacturing a microfluidic sensing cartridge comprising at least two microfluidic sensing devices, comprising the steps consisting in:
providing a general main plate having a first general side and a second general side and including at least two sets of recesses, one for each of said at least two microfluidic sensing devices, for defining a detection chamber, a first microfluidic path connecting said detection chamber to a first opening, a second microfluidic path connecting said detection chamber to a second opening, a third microfluidic path connecting said first microfluidic path to a third opening, and a waste chamber for each of said at least two microfluidic sensing devices, one of said recesses being provided in a first general side of said main plate for defining said detection chamber,
providing a first additional recess arranged in said second microfluidic path, for each of said at least two microfluidic sensing devices, between said second opening and said waste chamber, for defining a first restriction organ for restricting the circulation of fluids, said first restriction organ being intended to have a predefined fluidic resistance so as to be able to restrict the circulation of fluids in said second microfluidic path,
providing a second additional recess arranged in said third microfluidic path, for each of said at least two microfluidic sensing devices, for defining a second restriction organ for restricting the circulation of fluids, said second restriction organ being intended to have a predefined fluidic resistance so as to be able to restrict the circulation of fluids in said third microfluidic path,
providing a general sealing plate bearing at least one sensor as well as at least one electrically conducting track for each of said at least two microfluidic sensing devices,
sealing said first general side with said general sealing plate, so as to arrange said sensors substantially in alignment with said corresponding detection chambers,
providing a general cover plate for said second general side, and
sealing said second general side with said general cover plate.

15. A measurement method by implementation of a microfluidic sensing cartridge comprising a general housing having at least two microfluidic sensing devices each of which includes:
a first opening defining an inlet and/or an outlet for a liquid sample,
a detection chamber provided with at least one sensor,
a first microfluidic path connecting said first opening to said detection chamber, such that said detection chamber can be filled in with a predefined volume of the liquid sample so as to conduct at least one measure,
a second opening designed so as to allow the application of a negative and/or positive pressure within said housing,
a second microfluidic path connecting said second opening to said detection chamber,
a third opening designed so as to allow the application of a negative and/or positive pressure within said housing,
a third microfluidic path connecting said third opening to said first microfluidic path,
a waste chamber arranged in said second microfluidic path, between said detection chamber and said second opening, and
a first restriction organ, for restricting the circulation of fluids, arranged in said second microfluidic path, between said second opening and said waste chamber, said first restriction organ having a predefined fluidic resistance so as to restrict the circulation of fluids in said second microfluidic path
said microfluidic sensing cartridge further comprising:
a first distribution channel arranged in communication with said second opening of each of said at least two microfluidic sensing devices and having a first general opening designed so as to allow the application of a negative and/or positive pressure within said first distribution channel, and
a second distribution channel arranged in communication with said third opening of each of said at least two microfluidic sensing devices and having a second general opening designed so as to allow the application of a negative and/or positive pressure within said second distribution channel,
wherein the measurement method is applied on N liquid samples, N being equal to or being a multiple of the number of microfluidic sensing devices in the microfluidic sensing cartridge, and wherein the measurement method comprises the steps consisting in:
immersing said first opening of each of said at least two microfluidic sensing devices in a corresponding of said N liquid samples, in a substantially simultaneous manner,
applying a negative pressure in said general housing at least through said second general opening until said detection chamber of each of said at least two microfluidic sensing devices is filled in with a predefined volume of the corresponding liquid sample,
applying a positive pressure in said general housing through said second general opening until any excessive part of the liquid samples is removed at least from a portion of each of said first microfluidic paths located between said corresponding first opening and third microfluidic path,
conducting at least one measure on each of the at least two liquid samples by means of said corresponding at least one sensor, in a substantially simultaneous manner, and
extracting said first opening of each of said at least two microfluidic sensing devices out of the corresponding liquid samples before or after conducting said at least one measure, but before applying a negative pressure in said general housing through said first general opening to transfer the predefined volume of the liquid samples from each of said detection chambers into said corresponding waste chambers.

16. The method of claim 15, further comprising a calibration step for calibrating each of said at least two sensors.

17. The method of claim 15, further comprising a rinsing step of each of said at least two first microfluidic paths before immersing said first opening of each of said at least two microfluidic sensing devices in a corresponding of said at least N liquid samples, preferably by circulation of a buffer solution.

18. The method of claim 15, wherein application of said negative and positive pressures through said first and second general openings is implemented by means of a single pneumatic mechanism, in association with a valve.

19. The method of claim 15, wherein it is applied at least to a measurement relating to predefined molecules within a cell culture media.

20. The method of claim 15, wherein it is adapted for conducting measures relating to glucose or lactate.
